(19) United States
(12) Patent Application Publication
(10) Pub. No.: US 2008/0228564 A1
(43) Pub. Date: Sep. 18, 2008

(54) Weighted-Parameter Auction

(75) Inventors: David L. de Heer, Woodside, CA (US); David Hendler Sloo, Menlo Park, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/685,082

(22) Filed: Mar. 12, 2007

(51) Int. Cl. G06Q 30/00

(52) U.S. Cl. 705/14

(57) ABSTRACT

Techniques are described to provide a weighted auction, an example of which is to auction an opportunity to cause output of an advertisement in time-shifted content by a client. Bids may be selected to win the opportunity based at least in part on a plurality of weighted-auction parameters included in the plurality of bids.

### BACKGROUND

Users are exposed to content from a continually expanding variety of sources, including satellite radio, streaming media over the Internet, digital cable television programming, and so on. The ways in which users may interact with this content also continues to increase.

Techniques have been developed to enable users to “time-shift” an output of the content such that the user may choose to consume the content when so desired. A user, for instance, may employ a digital video recorder (DVR) to output content from a hard drive when desired, and thus “time-shift” the output of the content to a time that is convenient to the user.

The user may also employ techniques to time-shift the content as it is being output by the DVR through the use of one or more control functions. For example, a control function may be employed to fast forward through advertisements included in the content, such as commercials originally included in a broadcast of a television program. This ability to fast-forward through advertisements, however, has led to growing concern by content providers and advertisers that users of DVRs are not viewing the advertisements as originally intended. This concern has led to a perceived decrease in advertising opportunities and consequently may also lead to a decrease in revenue to content providers that provide these opportunities, such as television broadcasters.

Even though users may use the control function to “skip” a majority of the advertisements in the content, users do not typically skip through each of the advertisements in the content. For instance, the users may be more likely to view advertisements that are placed at particular points in the output of the content, such as at the beginning of a television program. Therefore, these particular points may have increased value over other points in the content, which may help the advertisers again reach the users and thereby provide revenue to content providers. Traditional techniques that were employed to provide advertising opportunities at these points, however, may not capture the true value of the opportunity, and thus result in lost potential revenue to the content provider.

### SUMMARY

Techniques are described to provide a weighted auction, an example of which is to auction opportunities to advertise in time-shifted content. In an implementation, an opportunity is auctioned to cause output of an advertisement in time-shifted content by a client. One of a plurality of bids are selected to win the opportunity based at least in part on a plurality of weighted-auction parameters included in the plurality of bids.

In another implementation, a user interface may be output that is configured to receive a plurality of inputs. The inputs may be used to assign weights (e.g., monetary values) to a plurality of auction parameters. A bid may be formed from the auction parameters to be submitted in an auction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques to auction advertising opportunities using weighted-auction parameters.

FIG. 2 is an illustration of an exemplary implementation of a user interface that is output on a display device of an advertiser. The user interface is configured to allow the advertiser to assign weights to auction parameters to arrive at a bid for an item being auctioned, such as an opportunity to advertise during output of time-shifted content.

FIG. 3 is a flow diagram depicting a procedure in an exemplary implementation in which a bid is formed for an auction of an opportunity to output an advertisement.

FIG. 4 is a flow diagram depicting a procedure in an exemplary implementation in which an auction is performed to raise priority of an advertisement for output in conjunction with time-shifted content.

FIG. 5 is a flow diagram depicting a procedure in an exemplary implementation in which a monetary amount is assigned to each of a plurality of auction parameters to form a bid and feedback is provided such that an advertiser may adjust a bid during an auction.

### DETAILED DESCRIPTION

Overview

Time-shifting of content has enabled users to view content when desired, and thus users are not limited to when the content is originally broadcast. Further, the time-shifting of content has also changed how users consume the content itself when being output. For example, a user of a digital video recorder (DVR) may fast forward through advertisements (e.g., television commercials) that were included in an original broadcast of a television program. This ability to control not only when content is output but also how the content is output however, has both a perceived and real effect on traditional advertising models that were used by content providers to collect revenue for providing the content.

A traditional television program, for instance, may be configured for linear playback and therefore include a plurality of advertising pods (i.e., groups) that contain advertisements. These advertisements may be provided by advertisers in order to reach a demographic that typically consumes the television program, such as males between the ages of 18 and 34 that watch a sporting event. Therefore, in this model there may be a significant number of opportunities in which to include an advertisement. These opportunities were traditionally sold by content providers for a set rate based on expected viewership of the content.

Advertisers, however, may perceive the time-shifting of content as defeating this model. For example, a user may cause output of a television program from local storage of a DVR. As the content is being output, the user may choose to fast forward through portions of the content, which in most cases are those portions that include advertisements, thereby reducing and even eliminating the perceived purpose of paying for the advertisement by the advertiser.

As previously described, users of DVRs do not typically skip each advertisement included in content and therefore opportunities may be identified in the output of the content, during which, a user is likely to view an advertisement even when the advertisement is included in time-shifted content. A user, for instance, may be more likely to view an advertisement at the beginning or end of a television program, at the beginning or end of an advertisement pod (i.e., advertisements grouped together for linear output during a break in the output of a television program), and so on. In another instance, a DVR may output advertisements at times and in sufficient sparseness that may lessen and even eliminate the user's desire to skip the advertisements. In this other instance, although there are fewer advertisements (and potentially advertisements of different formats), these advertisement have greater value. Therefore, these advertising opportunities have greater value for both linear and time-shifted output of the television program than other opportunities that are targeted toward linear output of the television program alone.

Further, content time-shifting may result in an increase in these advertising opportunities. For example, a user may watch additional television programs in a given amount of time (e.g., three “half-hour” television programs in approximately in hour) in time-shifted output as opposed to linear output due to the ability of the user to “skip” advertisements and other portions of the content that are not “of interest” to the user, such as a trailer showing what occurred during a previous episode of a television program. Traditional advertising models, however, did not address this distinction and therefore resulted in missed advertising opportunities for advertisers and consequently missed revenue opportunities for content providers.

Techniques are described to auction advertisements, such as for opportunities to advertise in time-shifted content. For example, an opportunity may be identified to output an advertisement in time-shifted content, such as to output a television commercial during output of a television program recorded on a DVR. This opportunity may then be auctioned to prospective advertisers which may bid to cause output of their advertisements by the DVR. In this way, the auction may be used to arrive at a “true market value” for output of the advertisement. Although an opportunity has been described as relating to identification of a “valuable” opportunity, it should be noted that the opportunity may be representative of any opportunity to output an advertisement.

Further, the bids placed by the prospective advertisers may be “rich” to more fully describe desired characteristics of users to be targeted by the advertisements. For example, a variety of auction parameters may be used to describe parameters of the DVR that is to output the advertisement (e.g., demographic information, whether the advertisement was previously output by the DVR), parameters of the context in which the advertisement is to be output (e.g., time of day, day of week, genre of television program), and so on. The auction parameters may be weighted by the advertiser such that more desirable parameters (e.g., a particular age range) are given greater weight than other parameters (e.g., a time of day), which may then be used to calculate a bid price for the advertising opportunity. For example, monetary values may be placed by a prospective advertiser on the various auction parameters. These values may then be used to calculate a total bid based on which of the parameters are met by the opportunity. Thus, these parameters may be used to more fully describe desirable opportunities and bid accordingly, further discussion of which may be found in relation to the following figures.

In the following discussion, an exemplary environment and user interface is first described that is operable to perform techniques to perform weighted auctions, such as to auction opportunities to output advertisements in relation to time-shifted content. Exemplary procedures are then described that may be employed in the exemplary environment, as well as in other environments. Although an auction is described in an advertising context in the following discussion, it should be readily apparent that a wide variety of goods and/or services may also be auctioned using similar weighted-parameter techniques without departing from the spirit and scope thereof.

Exemplary Environment and User Interface

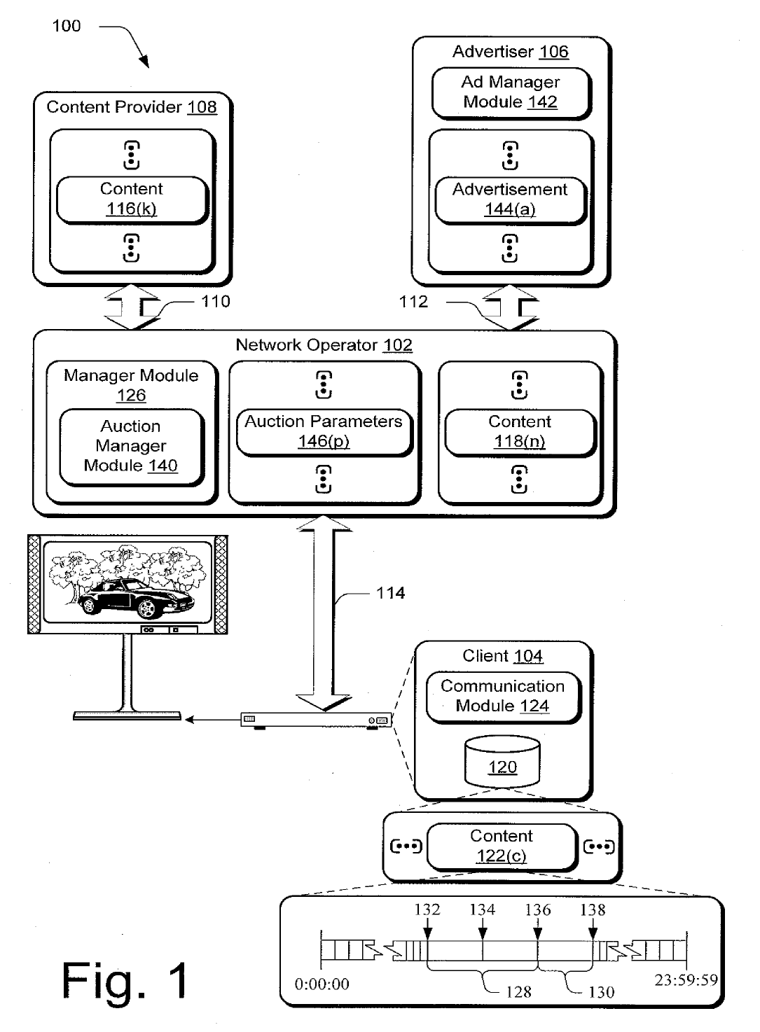

FIG. 1 is an illustration of an environment 100 in an exemplary implementation that is operable to employ techniques to auction advertising opportunities using weighted-auction parameters. The illustrated environment 100 includes a network operator 102 (e.g., a “head end”), a client 104, an advertiser 106 and a content provider 108 that are communicatively coupled, one to another, via network connections 110, 112, 114. In the following discussion, the network operator 102, the client 104, the advertiser 106 and the content provider 108 may be representative of one or more entities, and therefore reference may be made to a single entity (e.g., the client 104) or multiple entities (e.g., the clients 104, the plurality of clients 104, and so on). The advertiser 106, in portions of the following discussion, may also relate to a person and/or entity that operate a device. In other words, the advertiser 106 may describe a logical advertiser that includes users, software, and/or devices. Additionally, although a plurality of network connections 110-114 are shown separately, the network connections 110-114 may be representative of network connections achieved using a single network or multiple networks.

The client 104 may be configured in a variety of ways. For example, the client 104 may be configured as a computer that is capable of communicating over the network connection 114, such as a desktop computer, a mobile station, an entertainment appliance, a set-top box communicatively coupled to a display device as illustrated, a wireless phone, and so forth. Thus, the client 104 may range from a full resource device with substantial memory and processor resources (e.g., television-enabled personal computers, television recorders equipped with hard disk) to a low-resource device with limited memory and/or processing resources (e.g., traditional set-top boxes). For purposes of the following discussion, the client 104 may also relate to a person and/or entity that operate the client. In other words, client 104 may describe a logical client that includes a user, software and/or a machine.

The content provider 108 includes one or more items of content 116(k), where “k” can be any integer from 1 to “K”. The content 116(k) may include a variety of data, such as television programming, video-on-demand (VOD) files, one or more results of remote application processing, and so on. The content 116(k) is communicated over the network connection 110 to the network operator 102.

Content 116(k) communicated via the network connection 110 is received by the network operator 102 and may be stored as one or more items of content 118(n), where “n” can be any integer from “1” to “N”. The content 118(n) may be the same as or different from the content 116(k) received from the content provider 108. The content 118(n), for instance, may include additional data for broadcast to the client 104. For example, the content 118(n) may include electronic program guide (EPG) data from an EPG database for broadcast to the client 104 utilizing a carousel file system. The carousel file system repeatedly broadcasts the EPG data over an out-of-band (OOB) channel to the client 104 over the network connection 114. Distribution from the network operator 102 to the client 104 may be accommodated in a number of ways, including cable, radio frequency (RF), microwave, digital subscriber line (DSL), and satellite.

The client 104, as previously stated, may be configured in a variety of ways to receive the content 118(n) over the network connection 114. The client 104 typically includes hardware and software to transport and decrypt content 118(n) received from the network operator 102 for rendering by the illustrated display device. Although a display device is shown, a variety of other output devices are also contemplated, such as speakers.

The client 104 may also include digital video recorder (DVR) functionality. For instance, the client 104 may include a storage device 120 to record content 118(n) as content 122(c) (where “c” can be any integer from one to “C”) received via the network connection 114 for output to and rendering by the display device. The storage device 120 may be configured in a variety of ways, such as a hard disk drive, a removable computer-readable medium (e.g., a writable digital video disc), and so on. Thus, content 122(c) that is stored in the storage device 120 of the client 104 may be copies of the content 118(n) that was streamed from the network operator 102. Additionally, content 122(c) may be obtained from a variety of other sources, such as from a computer-readable medium that is accessed by the client 104, and so on.

The client 104 includes a communication module 124 that is executable on the client 104 to control content playback on the client 104, such as through the use of one or more “command modes”. The command modes may provide non-linear playback of the content 122(c) (i.e., time shift the playback of the content 122(c)) such as pause, rewind, fast forward, slow motion playback, and the like. For example, during a pause, the client 104 may continue to record the content 118(n) in the storage device 120 as content 122(c). The client 104, through execution of the communication module 124, may then playback the content 122(c) from the storage device 120, starting at the point in time the content 122(c) was paused, while continuing to record the currently-broadcast content 118(n) in the storage device 120 from the network operator 102.

When playback of the content 122(c) is requested, the communication module 124 is executed on the client 104 to retrieve the content 122(c). The communication module 124 may also restore the content 122(c) to the original encoded format as received from the content provider 108. For example, when the content 122(c) is recorded on the storage device 120, the content 122(c) may be compressed. Therefore, when the communication module 124 retrieves the content 122(c), the content 122(c) is decompressed for rendering by the display device.

The network operator 102 is illustrated as including a manager module 126. The manager module 126 is representative of functionality to configure content 118(n) for output (e.g., streaming) over the network connection 114 to the client 104. The manager module 126, for instance, may configure content 116(k) received from the content provider 108 to be suitable for transmission over the network connection 114, such as to “packetize” the content for distribution over the Internet, configuration for a particular broadcast channel, and so on.

Thus, in the environment 100 of FIG. 1, the content provider 108 may broadcast the content 116(k) over a network connection 110 to a multiplicity of network operators, an example of which is illustrated as network operator 102. The network operator 102 may then stream the content 118(n) over a network connection to a multitude of clients, an example of which is illustrated as client 104. The client 104 may then store the content 118(n) in the storage device 120 as content 122(c), such as when the client 104 is configured to include digital video recorder (DVR) functionality.

The content 118(n) may also be representative of video-on-demand (VOD) content that is streamed to the client 104 when requested, such as movies, sporting events, and so on. For example, the network operator 102 may execute the manager module 126 to provide a VOD system such that the content provider 108 supplies content 116(k) in the form of complete content files to the network operator 102. The network operator 102 may then store the content 116(k) as content 118(n). The client 104 may then request playback of desired content 118(n) by contacting the network operator 102 (e.g., a VOD server) and requesting a feed of the desired content.

In another example, the content 118(n) may further be representative of content (e.g., content 116(k)) that was recorded by the network operator 102 in response to a request from the client 104, in what may be referred to as a network DVR example. Like VOD, the recorded content 118(n) may then be streamed to the client 104 when requested. Interaction with the content 118(n) by the client 104 may be similar to interaction that may be performed when the content 122(c) is stored locally in the storage device 120.

The client 104, for instance, may execute the communication module 124 to initiate control functions for interacting with the content 122(c). For example, the control functions may include control functions to time-shift output of the content 122(c) as well as channel selection, electronic program guide (EPG) navigation, purchase of on-demand content, and so on. In another implementation, the communication module 124 provides media player functionality to play media having audio and/or visual data, such as a satellite radio having storage to record songs and/or music videos locally on the client 104.

The communication module 124 may be utilized to time-shift an output of content (e.g., audio-visual content) from a variety of different sources, such as the locally stored content 122(c) and/or the remotely stored content 118(n). Regardless of the source, the time-shifted content may provide a variety of opportunities in which to output advertisements.

As illustrated for content 122(c) of FIG. 1, for instance, a timeline is shown of content 122(c) that includes first and second television programs 128, 130. Opportunities, at which, a user is likely to view an advertisement are depicted in the timeline through the use of arrows. For example, a first opportunity 132 is depicted as occurring at a start of the first television program 128, a second opportunity 134 is depicted as occurring during a break in an output of the first television program 128 (e.g., during a pause event), a third opportunity 136 is depicted between the output of the first and second television programs 128, 130 and a fourth opportunity 138 is depicted after output of the second television program 130. Although these advertisement opportunities are depicted in conjunction with content 122(c) that is local to the client 104, similar opportunities may be available from time-shifted content 118(n) available over the network connection 114, such as in a NDVR example discussed above. As previously described, these opportunities 132-138 may be valuable both to an advertiser 106 as well as a network operator 102 because a user of the client 104 may have an increased likelihood of actually viewing an advertisement output at this advertisement opportunity.

Accordingly, techniques are described that may be used to auction the opportunities 132-138 to advertisers 106. For example, the network operator 102 may include an auction manager module 140 that is representative of functionality to provide an auction, such as to auction the opportunities 132-138 to output advertisements in conjunction with the content 122(c). Although the auction manager module 140 is depicted as a part of the network operator 102, the auction may be provided in a variety of ways, such as through use of a third-party service separate from the network operator 102, as a part of the client 104, and so on.

Bids to be submitted to the auction by the advertiser 106 may be formed in a variety of ways. The advertiser 106, for instance, may employ an ad manager module 142 that is representative of functionality of the advertiser 106 to provide advertisements 144(a) (where “a” can be any integer from one to “A”). Through interaction with the ad manager module 142, the advertiser 106 may also view auction parameters 146(p) (where “p” can be any integer from one to “P”) provided by the auction manager module 140 that may be used as a basis for the bid. The auction parameters 146(p) are representative of a variety of information that may be taken into account by the advertiser 106 to form the bid.

The auction parameters 146(p), for instance, may include parameters of the client 104 that is to output the advertisement (and thus may be referred to as “client parameters”). For example, the client parameters may describe hardware and/or software capabilities of the client 104, output frequency of the advertisement 144(a) by the client 104, whether the advertisement 144(a) is available from the storage device 120 of the client 104, whether the advertisement 144(a) was previously output by the client 104, and so on.

The auction parameters 146(p) may also relate to a context in which the advertisement 144(a) is to be output. For example, the context may include where the advertisement is to be output in relation to an output of the time-shifted content (e.g., at a beginning, during a commercial break or at the end), type of opportunity (e.g., during a pause event, in response to a search or in a bumper ad), type of the content (e.g., in a movie or television program), genre of the content (e.g., drama or sports), time of day the advertisement is to be output (e.g., day or night), day of week the advertisement is to be output, order of the advertisement in an advertisement pod (e.g., beginning, middle or end), relation of the advertisement to another advertisement to be output by the client 104 (e.g., same type of product or service), and so on.

The auction parameters 146(p) may then be used by the advertiser 106 in a variety of different ways to bid for the opportunities 132-138 in the auction. For example, the auction parameters 146(p) may be individually weighted by the advertiser 106 to reflect the desires of the advertiser 106 with respect to prospective consumers. For instance, the ad manager module 142 may be executed to output a user interface that accepts inputs to assign a weight to the various auction parameters 146(p). This weighting of the parameters may then be used to calculate a bid to be submitted on behalf of the advertiser 106 for auction of the opportunity based on which of the parameters are met by the opportunity. For example, the network operator 102 may receive a matrix of auction parameters 146(p) that have been assigned values by the advertiser 106. The network operator 102 may then calculate a bid price based on the auction parameters 146(p). In another example, the advertiser 106 may communicate in “real-time” with the network operator 102 such that the advertiser 106 may update bids as the auction progresses. A variety of other examples are also contemplated.

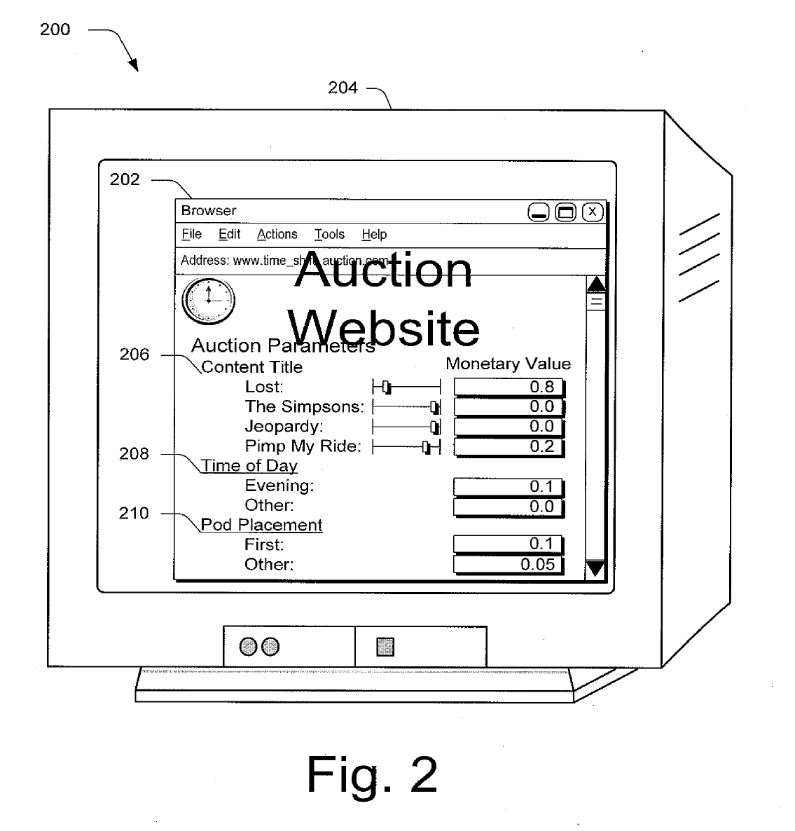

FIG. 2 illustrates an exemplary implementation 200 of a user interface 202 being output on a display device 204 of an advertiser 106, through which, the advertiser 106 may assign weights to auction parameters. The user interface 202 is illustrated as being output through use of a browser, although a variety of other user interfaces are also contemplated.

The user interface 202 includes a plurality of auction parameters 146(p) from FIG. 1 that include content title 206, time of day 208 and pod placement 210. Through interaction with the user interface 202, the advertiser may set weights to a variety of parameters. For example, a plurality of “slider-bars” is illustrated for the auction parameter content title 206. Through interaction with one or more of the slider bars, monetary weights may be assigned to the content titles, such as to assign a greater weight to the title “Lost” than to “The Simpsons” “Jeopardy” or “Pimp My Ride” content titles.

In another example, the advertiser 106 may enter monetary values directly into the user interface, such as by assigning a value of “0.1” for “evening” under time of day 208 and “0.0” for “other” under time of day. These weights may then be used to calculate an overall bid price for the auction, further discussion of which may be found in relation to the following exemplary procedures. In this way, “rich” bids may be provided by the advertisers that may address a wide variety of auction parameters 146(p) to decide whether to advertise and how much to spend for advertising in a given situation.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to provide an auction having weighted parameters are platform-independent, meaning that the techniques may be implemented on a variety of commercial computing platforms having a variety of processors.

Exemplary Procedures

The following discussion describes auction techniques that may be implemented utilizing the previously described environment, systems, user interfaces and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interface 202 of FIG. 2.

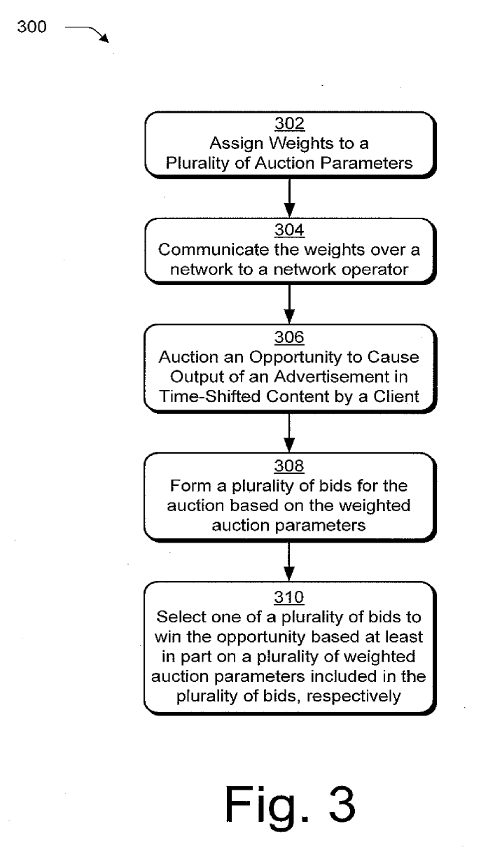

FIG. 3 depicts a procedure 300 in an exemplary implementation in which a bid is formed for an auction of an opportunity to output an advertisement. Weights are assigned to a plurality of auction parameters (block 302). As shown in FIG. 2, for instance, a user may interact with slider bars to assign relative weights to a plurality of auction parameters and thereby indicate which of the parameters are relatively more important than other parameters, if any. A variety of other instances are also contemplated, such as by assigning the weights based on a percentage of an overall total (e.g., apply “X” amount of a maximum bid price for sporting events), through an ordered ranking of the weights, and so on. The weights are then communicated over a network to the network operator (block 304), such as over the network connection 112 to the network operator 102.

An opportunity is auctioned to cause output of an advertisement in time-shifted content by a client (block 306). The auction, for instance, may relate to an opportunity to output an advertisement with content 122(c) stored locally on the client 104 (e.g., a DVR), content 118(n) stored remotely over a network connection 114 (e.g., a NDVR), and so on.

A plurality of bids are formed for the auction based on the weighted auction parameters (block 308), which may be performed in a variety of ways. For example, the network operator 102 may compute the bids for each of a plurality of advertisers based on the weighting of the auction parameters met by the client 104 that is the subject of the advertising opportunity.

One of a plurality of bids are then selected to win the opportunity based at least in part on a plurality of weighted-auction parameters included in the plurality of bids, respectively (block 310). For example, the auction parameters met by the opportunity (e.g., time of day, genre, whether the client previously output advertisements from the advertiser, whether this is a “pause”) were used to calculate a total bid price in block 308. Total prices for each of the bids may then be used to select a “winner” of the auction such that an advertiser winning the auction is granted the opportunity to output the advertisement 144(a). Thus, the auction may be used to arrive at a “true market value” for the opportunity based on additional information provided via the auction parameters. The auction techniques may be employed in a variety of other situations, such as to increase priority of an advertisement, further discussion of which may be found in relation to the following figure.

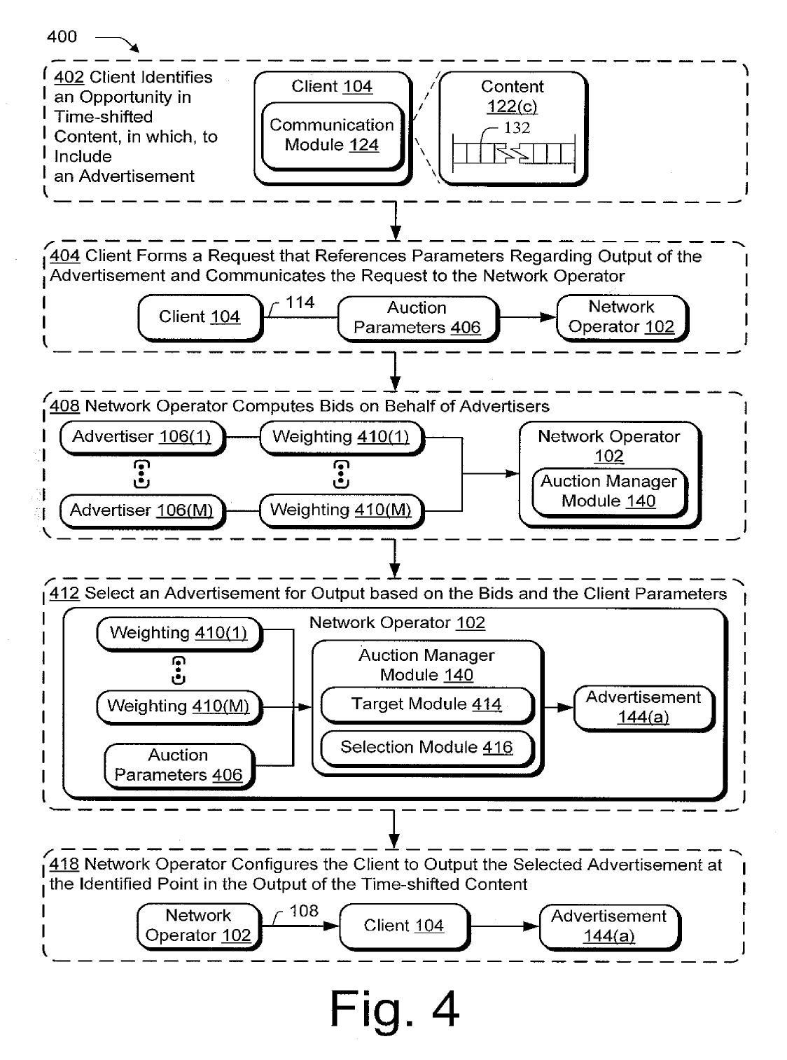

FIG. 4 depicts a procedure 400 in an exemplary implementation in which an auction is performed to raise priority of an advertisement for output in conjunction with time-shifted content. A client identifies an opportunity in time-shifted contenting which to include an advertisement (block 402). The client 104, for example, may execute a communication module 124 to initiate output of content 122(c), such as a television program stored in storage device 120. Because of this, the communication module 124 may identify particular points in the output of the content 122(c), at which, a user is likely to view advertisements, such as the beginning of the output while the content 122(c) is being paused, at an end of the output of the content 122(c), and so on.

The client may then form a request that references auction parameters regarding output of the advertisement and communicates the request to the network operator (block 404). The auction parameters 406, for instance, may reference parameters that describe the context and the client 104 that is to output the content 122(c), such as individual ad playback frequency, what type of content is being played, type of opportunity that is available (e.g., during a pause, at the end of content 122(c) output), which advertisements are stored on the client 104 in the storage device 120, and so on.

The network operator may also compute bids on behalf of advertisers (block 408). For example, the network operator 102 may set a base price for new (i.e., original) advertisement opportunities for linear playback of the content 122(c), such as in an original broadcast. The network operator 102 may then make available, via auction, an ability to improve priority of advertisements. The advertisers 106(1)-106(M), for instance, may each set an amount per output and a total budget that the respective advertiser is willing to spend to have one or more advertisements 144(a) output. The advertisers 106 may then apply a weighting 410(1)-410(M) to auction parameters 146(p) (such as a type of opportunity, context/content, day part, advertisement pod placement, and so on as previously described) to be used to compute bids on behalf of the respective advertisers 106(1)-106(M).

The network operator 102, through execution of the auction manager module 140, may then select an advertisement 144(a) for output based on the weightings 410(1)-410(M) and the auction parameters 406 (block 412). For example, the auction manager module 140 may include a target module 414 that is representative of functionality to compute a total bid value for each of the weightings 410(1)-410(M) based on the auction parameters 406. The target module 414, for instance, may take into account a type of opportunity (e.g., a bumper advertisement, advertisements in a pause), type of content (e.g., television program, movie), time of day, day of week, date, other advertisements to be included in an advertisement pod (e.g., to ensure that no more than one category of advertisement plays in a pod, such as a car advertisement), and so on. The target module 414 may then use these parameters to compute a bid price for each of the weightings 410(1)-410(M) based on the weighting of those parameters.

Additionally, the auction manager module 140 may execute a selection module 416 that may take additional considerations into account when selecting a “winner” of the auction. The selection module 416, for instance, may filter an ordered list of bids computed by the target module 414 for considerations such as individual advertisement playback frequency, known list of advertisements stored on the client 104, and so on. These considerations may then be used to order the advertisements for playback in relation to the content 122(c).

For example, the client 104 may initiate output of a DVR recording in the afternoon of a nighttime football game the day after the game was originally broadcast (e.g., “aired”). Consequently, there may be a two-part advertisement pod that is to precede output of the content 122(c), e.g., opportunities to output two advertisements. The advertisers for this football game may include a home-products retailer, a beer company, a foreign car company, a domestic car company, a first soft-drink maker, and a second soft-drink maker. Each of these advertisers in this example have opted to both pay for inclusion into new advertisement opportunities and to bid for improved priority. The bids may be weighted by the advertisers as shown in the following table:

| | Type of | | Day | Pod | | Total |
|---|---|---|---|---|---|---|
| Advertiser | avail | Context | Part | Placement | Exposure | Budget |
| Home- | .05 for | .30 for | .10 for | .10 for 1^{st} | .25 for 1^{st} | $1000 |
| Products | DVR | Football | eve | .05 other | .05 for | |
| Retailer | .03 for | Game | .05 | | other | |
| | VOD | | other | | | |
| Beer | .05 for | .45 for | .10 for | .15 for 1^{st} | .25 for 1^{st} | $1000 |
| Company | DVR | Football | eve | .05 other | .05 for | |
| | .03 for | | .0 for | | other | |
| | VOD | | other | | | |
| Foreign | .05 for | .45 for | .10 for | .15 for 1^{st} | .20 for 1^{st} | $1000 |
| Car | DVR | Football | eve | .05 other | .05 for | |
| Company | .03 for | | .05 | | other | |
| | VOD | | other | | | |
| Domestic | .05 for | .45 for | .10 for | .15 for 1^{st} | .25 for 1^{st} | $1000 |
| Car | DVR | Football | eve | .05 other | .05 for | |
| Company | .03 for | | .05 | | other | |
| | VOD | | other | | | |
| First Soft- | .05 for | .45 for | .10 for | .15 for 1^{st} | .10 for 1^{st} | $1000 |
| Drink | DVR | Football | eve | .05 other | .05 for | |
| Maker | .03 for | | .05 | | other | |
| | VOD | | other | | | |
| Second | .05 for | .35 for | .10 for | .15 for 1^{st} | .25 for 1^{st} | $1000 |
| Soft-Drink | DVR | Football | eve | .05 other | .05 for | |
| Maker | .03 for | | .05 | | other | |
| | VOD | | other | | | |

Although the bids may appear fairly similar, there are some differences based on individual business differences. For example, the beer company does not want its advertisements to play in day-parts other than in the evening. The home-products retailer places less value on being first in the pod. The domestic car company is willing to pay less of a premium for the first ad exposure. The foreign car company and the home-products retailer are willing to pay less of a premium to play their advertisements in relation to a football game.

When the auction manager module 140 computes what advertisements are to be output in the advertisement pod preceding the football game, it detects that six companies have bid to place ads into the advertisement pod that has two advertising opportunities. The beer company is immediately eliminated because the opportunities occur at the wrong day-part.

The foreign car company, the domestic car company, and the first soft-drink maker have the highest bids to be placed first in the pod. However, through processing by the auction manager module 140, it may be determined that the client 104 has already output the first soft-drink maker advertisement twice before, and therefore the first soft-drink maker is not willing to pay as much for this third exposure.

In this example, the target module 414 may determine that this is a first exposure for the domestic car company and the foreign car company, and that the domestic car company is willing to pay more for the opportunity than the foreign car company. Therefore, the domestic car company “wins” the first position in the advertisement pod. The highest bid on the second position is from the foreign car company, but because there is another car advertisement in the advertisement pod, the home-products retailer “wins” the second position in the advertisement pod.

The network operator may then configure the client to output the selected advertisement at the identified point in the output of the time-shifted content (block 418). For example, the network operator 102 may provide an ordered list having addresses of “where” the client 104 may locate the advertisement, may stream the advertisements to the client for storage and/or immediate output, and so on. Thus, in this example priority of advertisement is auctioned based on weighting of the auction parameters by the advertisers as well as other considerations, such as whether the client 104 has previously output the advertisement, other advertisements within an advertisement pod, and so forth. Although this example describes an instance in which feedback was not provided until after an advertisement was selected for output, feedback may also be provided during and/or after the auction such that the advertisers may adjust their bids during the auction process or after the auction process as desired, an example of which may be found in relation to the following figure.

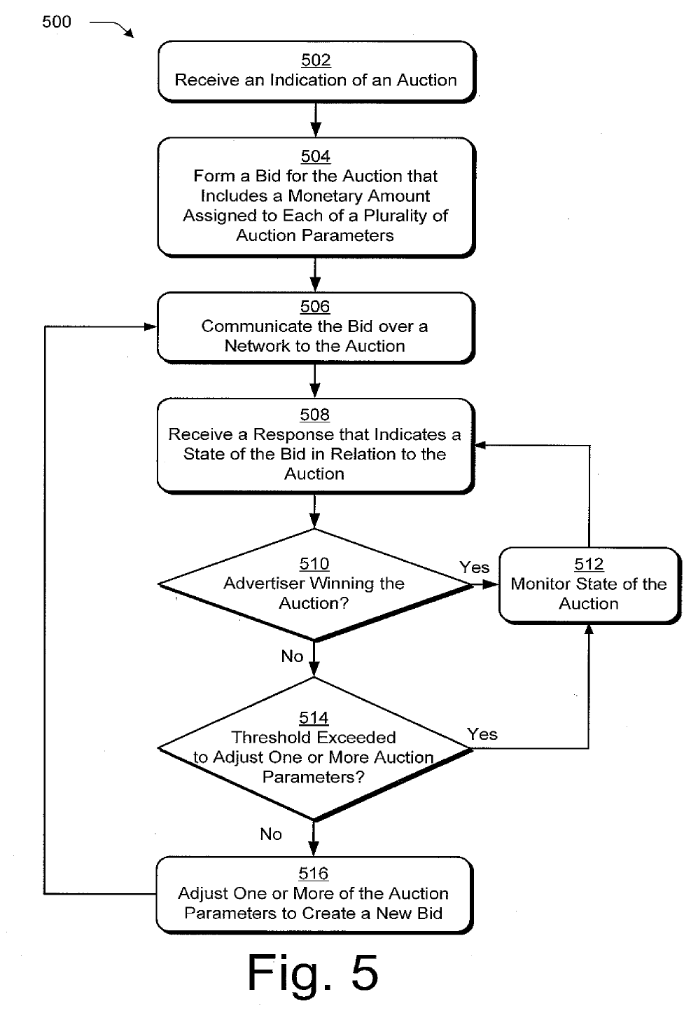

FIG. 5 depicts a procedure 500 in an exemplary implementation in which a monetary amount is assigned to each of a plurality of auction parameters to form a bid and feedback is provided such that an advertiser may adjust bids during the auction. An indication of an auction is received (block 502) by an advertiser. The advertiser 106, for instance, may receive an email notification, logon to an auction website as shown in FIG. 2, and so on.

A bid is formed for the auction that includes a monetary amount assigned to each of a plurality of auction parameters (block 504). The advertiser 106, for instance, may set monetary values for the plurality of auction parameters (e.g., content title, time of day and pod placement 206-210) as shown in FIG. 2 such that compliance (e.g., existence or absence) with the parameters may be used to determine a total bid for the auction. The bid is then communicated over the network to the auction (block 506), such as via email, through interaction with the user interface 202 of FIG. 2, and so on.

The advertiser then receives a response that indicates a state of the bid in relation to the auction (block 508). The advertiser 106, for instance, may view the user interface 202 that provides a ranking of the advertiser's bid in relation to other bids that are submitted in the auction. The user interface 202 may also provide the monetary amounts included in each of the bids or keep this information “secret” from the other advertisers.

A determination is made as to whether the advertiser is winning the auction (decision block 510). For example, the advertiser may again view the user interface to determine the advertiser's ranking. In another example, this may be performed automatically and without user intervention, such as through execution of the ad manager module 142. A variety of other examples are also contemplated.

When the advertiser is winning the auction (“yes” from decision block 510), the advertiser may continue to monitor the state of the auction (block 512). However, when the advertiser is not winning the auction (“no” from decision block 510), a decision is made as to whether a threshold has been exceeded to adjust one or more auction parameters (decision block 514). For example, the advertiser 106 may set a maximum amount for a bid. Therefore, if that amount is exceeded, then the state of the auction may still be monitored (block 512) but an adjustment is not made at that time.

However, when the threshold has not been exceeded to adjust one or more auction parameters (“no” from decision block 514), one of more of the auction parameters are adjusted to create a new bid (block 516). For example, the advertiser 106 may view the user interface 202 and adjust one or more of the parameters 206-210 to increase the bid price. In another example, this adjustment may be performed automatically by the ad manager module 142. For example, the ad manager module 142 may determine which of the auction parameters may be adjusted to arrive at a “winning” bid and adjust the parameters accordingly to create the new bid. This new bid may then be communicated over the network to the auction (block 506) and the advertiser may continue to monitor the progress of the auction. Thus, in this way the advertiser may participate in the auction in “real time”, either manually through monitoring a user interface or automatically through execution of an ad manager module 142. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
providing an opportunity to an advertiser to have an advertisement placed in time-shifted content;
selecting one of a plurality of bids to win the opportunity based on a plurality of parameters included in the bids.

2. A method as described in claim 1, wherein at least one of the auction parameters describes a parameter that is particular to the client that is to output the advertisement.

3. A method as described in claim 2, wherein the at least one parameter includes:
output frequency of the advertisement by the client;
availability of the advertisement in local storage on the client; or
whether the advertisement was previously output by the client.

4. A method as described in claim 1, wherein one or more of the auction parameters describe parameters particular to a context in which the advertisement is to be output.

5. A method as described in claim 4, wherein the one or more auction parameters include:
where the advertisement is to be output in relation to an output of the time-shifted content;
type of opportunity;
type of the time-shifted content;
title of the time-shifted content;
genre of the time-shifted content;
time of day the advertisement is to be output;
day of week the advertisement is to be output;
order of the advertisement in an advertisement pod; or
relation of the advertisement to another advertisement.

6. A method as described in claim 1, wherein the opportunity to place the advertisement in the time-shifted content includes output of the advertisement:
before the time-shifted content is output;
at a pause in the output of the time-shifted content;
concurrently during output of the time-shifted content; or
after output of the time-shifted content.

7. A method as described in claim 1, wherein the plurality of auction parameters are weighted such that a monetary amount is assigned to one or more of the auction parameters.

8. A method as described in claim 1, wherein the time-shifted content is audio/visual content.

9. A method as described in claim 1, wherein the time-shifted content is stored locally by the client.

10. A method as described in claim 1, wherein the time-shifted content is stored remotely over a network from the client.

11. A method as described in claim 1 wherein the auctioned opportunity is to increase priority of the advertisement in an advertisement pod.

12. A method comprising:
forming a bid for an auction that includes a monetary amount assigned to each of a plurality of auction parameters in the bid; and
receiving a response that indicates a state of the bid in relation to the auction.

13. A method as described in claim 12, wherein the state indicates a current status of the bid in relation to one or more other bids that were submitted to the auction.

14. A method as described in claim 12, further comprising adjusting the monetary amount assigned to at least one of the auction parameters.

15. A method as described in claim 14, wherein the adjusting is performed automatically and without user intervention based on whether the bid is winning the auction and whether a threshold is exceeded to adjust to the at least one parameter.

16. One or more computer-readable media comprising computer-executable instructions that, when executed, direct a computer to output a user interface that is configured to receive a plurality of inputs to assign weights to a plurality of auction parameters and form a bid from the auction parameters to be submitted in an auction.

17. One or more computer-readable media as described in claim 16, wherein:
the bid is to be submitted for a plurality of auction opportunities; and
each said auction parameter in the bid pertains to each said auction opportunity.

18. One or more computer-readable media as described in claim 16, wherein the auction is for an opportunity to cause an advertisement to be output in relation to time-shifted content.

19. One or more computer-readable media as described in claim 16, wherein the user interface is further configured to accept inputs to adjust the assigned weights during the auction.

20. One or more computer-readable media as described in claim 16, wherein the computer-executable instructions further configure the computer to output the formed bid to be communicated over a network to one or more computers that perform the auction.
